(19) United States
(12) Patent Application Publication
(10) Pub. No.: US 2014/0246094 A1
(43) Pub. Date: Sep. 4, 2014

(54) ASYMMETRIC CYANINE DYES FOR PHOTOVOLTAIC APPLICATIONS

(71) Applicant: Giuseppe Caputo, Torino (IT)

(72) Inventor: Giuseppe Caputo, Torino (IT)

(73) Assignee: PIANETA S.R.L., Settimo Torinese, Torino (IT)

(21) Appl. No.: 14/240,981

(22) PCT Filed: Aug. 24, 2012
(86) PCT No.: PCT/IB2012/054301

§ 371 Date: Feb. 25, 2014

(30) Foreign Application Priority Data
Aug. 26, 2011 (IT) TO2011A000778

(51) Int. Cl. H01G 9/20; C09B 57/02; C09B 57/00

(52) U.S. Cl. CPC H01G 9/2059; C09B 57/008; C09B 57/00; C09B 57/02
USPC 136/263; 548/511; 548/178; 548/217; 548/467; 548/406; 548/440; 546/66

(57) ABSTRACT

Asymmetric dyes of the D-π-A type have the Formula (1), including the valence tautomers thereof. The dyes of Formula (1) are suitable for use in dye-sensitized solar cells (DSSC), in photoelectrochemical devices or in photonic devices. A solar cell and a device for photoelectric conversion contain an asymmetric dye of Formula (1). The dyes of Formula (1) are also suitable for conjugating with optically active nanoparticles (NP).

The present invention relates to dyes of the D-π-A type having a broad conjugated system and a broad spectrum of absorption of electromagnetic radiation and containing a reactive functional group that allows conjugation thereof with organic and inorganic compounds. These dyes have a broad absorption spectrum and very high extinction coefficients. The compounds according to the present invention can be used in dye-sensitized solar cells (DSSC), in photoelectrochemical devices or in photonic devices.

The dyes of the present invention are characterized in that they are strongly polarized by the presence of an electron-donating group D at one end and of an electron-accepting group A at the other end, linked by a π conjugated system. They are further characterized by the presence of a heterocyclic nucleus substituted in one of the positions of the benzene ring, or a benzothiazole, benzoxazole, indole, indolenine or quinoline nucleus which, in the structure of the compounds of the present invention, constitute the electron-accepting group A.

Dyes characterized by the presence of electron donors and electron acceptors at the ends of a chromophore were recently investigated for their properties of electron transfer in the excited state to a semiconductor in dye-sensitized photovoltaic cells. J. Preat et al. in J. Phys. Chem. C, 2009, Vol. 113, p. 16821 ff., show the structure of the D-π-A type (donor-bridge-acceptor) of a dye and the properties of some molecules characterized by said structure.

Hagberg et al. in J. Am. Chem. Soc., 2008, Vol. 130, p. 6259 ff., show dyes of the same type D-π-A, in which the donor is triphenylamine and the acceptor is a cyanoacrylic group, with good conversion efficiencies of solar energy when used in dye-sensitized solar cells.

Furthermore, Kim et al. in J. Am. Chem. Soc., 2006, Vol. 128, p. 16701 ff. describe dyes of the D-π-A type with a bisfluorenylphenyl electron donor and a cyanoacrylic electron acceptor. These too show good performance in solar energy conversion in dye-based cells.

The main drawback of all the aforementioned dyes is that they absorb below 500 nm and therefore do not capture most of the solar radiation. A second drawback is the low molar extinction coefficients.

Other dyes of the D-π-A type are discussed in Choi et al. in Mater. Chem., 2010, Vol. 20, p. 3280 ff. The dyes illustrated in this work are characterized by a chromophore of the squarate type and the absorption spectrum of the compounds is characterized by a peak above 650 nm.

Many dyes have been used for impregnating titanium dioxide in cells of the DSSC type. The dyes of the ruthenium polypyridine complex type, for example, have proved very efficient for use in cells of the DSSC type, but ruthenium is an expensive rare metal and the compounds synthesized have low molar extinction coefficients. The dyes of the squaraine type are completely organic and do not contain ruthenium or other metals, but absorb radiation with a very narrow spectrum centred around 650 nm, and for this reason fail to capture a large proportion of solar radiation. Other organic dyes, in contrast, have proved effective in absorbing solar radiation below 500 nm, and again fail to capture a large proportion of the radiation.

In fact the spectrum of solar radiation at ground level has an emission peak that extends from about 500 nm to about 650 nm. Therefore the use of dyes that have absorption peaks in this region of the spectrum is particularly desirable. An organic dye is also required to have properties of resistance to photodegradation and the presence of a reactive group capable of binding the dye stably to the semiconductor and of facilitating the transfer of electrons.

Compounds of the D-π-A type known in the prior art are for example the molecule called TA-St-CA described in Hwang et al. (Chem. Commun., 2007, page 4887) and the molecule called D5 described in Hagberg et al. (Chem. Commun., 2006, page 2245). The structures of both molecules are of the D-π-A type in which the electron-donating group is a triphenylamine, the bridge is —CH═CH— and the electron-attracting group is 2-cyanophenylpropenoic acid in the case of TA-St-CA and 2-cyanothiophenylpropenoic acid in the case of D5. The absorption peak of TA-St-CA is at 386 nm and the peak of D5 is 476 nm.

Other compounds of the D-π-A type are described in Koumura et al. (Journal of the American Chemical Society, 2006, volume 128, page 14256). The compounds designated MK-1, MK-2, MK-3 have in common the electron-donating group 3-amino-9-ethylcarbazole and the electron-accepting group 2-cyanothiophenylpropenoic acid, while the conjugated system consists of two, in the case of MK-1 and MK-3, or three, in the case of MK-2, thiophene groups joined together. The absorption peaks of the three molecules are at 463 nm, 473 nm and 443 nm for MK-1, MK-2 and MK-3 respectively.

Analysis of the state of the art therefore identifies a need for dyes of the D-π-A type with absorption spectra having a peak between 500 and 650 nm or of dyes with an absorption peak below 500 nm or above 650 nm, but with high molar extinction coefficients.

The drawbacks of the prior art are overcome with the dye molecules according to the present invention, whose general structure is the following Formula (1), including the valence tautomers thereof:

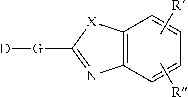

in which X is selected from —C(CH₃)₂, —O, —S, —CH═CH, or

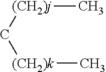

with j=1-20 and k=1-20;
R′ is selected from —COOH, —OH, —C≡N, —CHO, —PO₃H, —PO₃⁻, —B(OH)₂,

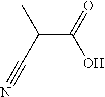

and —R₁₅—Y₁ in which R₁₅ is a linear or branched, saturated or unsaturated alkyl chain, having from 3 to 30 carbon atoms, preferably from 4 to 12, in which one or more carbon atoms are optionally each substituted with a component selected independently from an oxygen or sulphur atom, an —NH— or —CONH— group, or a cyclic grouping of carbon atoms with 4, 5 or 6 members, aromatic or non-aromatic, in which one or more carbon atoms are optionally each substituted with a heteroatom selected independently from oxygen, sulphur, nitrogen or selenium and in which Y₁ is selected from the group consisting of hydrogen, carboxyl, carbonyl, amino, sulphydryl, thiocyanate, isothiocyanate, isocyanate, maleimide, hydroxyl, phosphoroamidite, glycidyl, imidazolyl, carbamoyl, anhydride, bromoacetamide, chloroacetamide, iodoacetamide, sulphonyl halide, acyl halide, aryl halide, hydrazide, succinimidyl ester, hydroxysulphosuccinimide ester, phthalimide ester, naphthalimide ester, monochlorotriazine, dichlorotriazine, mono- or dihalo-substituted pyridine, mono- or dihalo-substituted diazine, aziridine, imide ester, hydrazine, azidonitrophenyl, azide, 3-(2-pyridyldithio)-propionamide, glyoxal, aldehyde, nitrophenyl, dinitrophenyl, trinitrophenyl, —C≡CH and

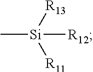

in which R₁₁, R₁₂ and R₁₃ are selected independently of one another from the group consisting of methyl, ethyl, propyl, isopropyl, —OCH₃, —OCH₂CH₃, —OCH₂CH₂CH₃, —OCH(CH₃)₂, —OCH₂CH₂OCH₃, —Cl, —Br, —I, —N(CH₃)₂,

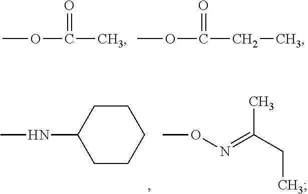

R″ is selected from hydrogen, —COOH, —OH, —C≡N, —CHO, —PO₃H, —PO₃⁻, —B(OH)₂,

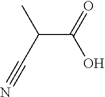

and —R₁₆—Y₂ in which R₁₆ is selected from any one of the meanings of R₁₅ and Y₂ is selected from any one of the meanings of Y₁;
G is a conjugated system or forms a conjugated system with the adjacent heterocyclic nucleus, the conjugated system consisting of 2 to 200 carbon atoms in which one or more carbon atoms are optionally each substituted with a component selected independently from an oxygen, sulphur, nitrogen, or silicon atom, an —NH— or —CONH— group, or an aromatic grouping of carbon atoms with 4, 5 or 6 members, in which one or more carbon atoms are optionally each substituted with a heteroatom selected independently from oxygen, sulphur, nitrogen, silicon or selenium;
D is an electron-donating group selected from the group consisting of:

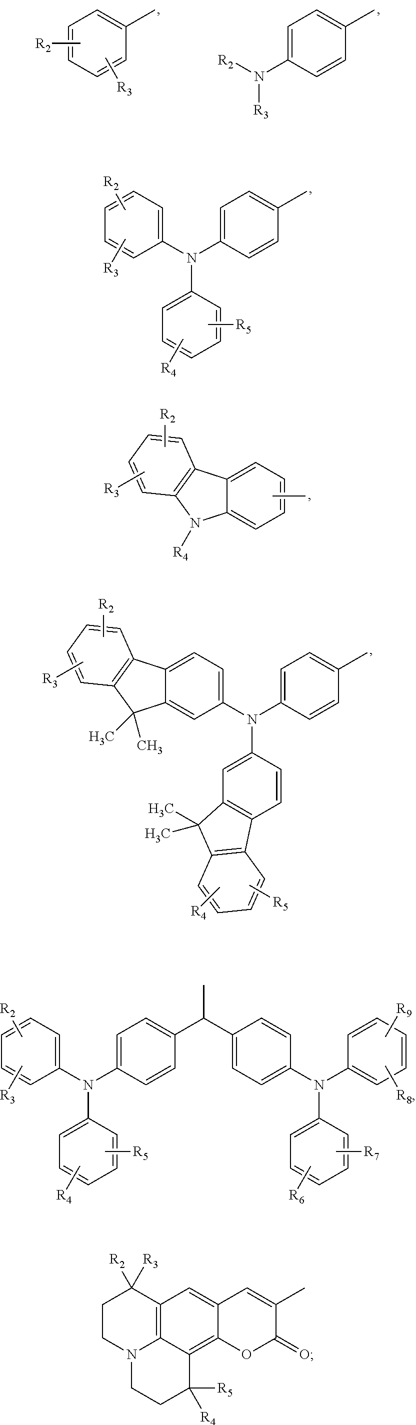

R₂, R₃, R₄, R₅, R₆, R₇, R₈, R₉ are substituents and are selected independently from the group consisting of hydrogen, hydroxyl, methyl, ethyl, propyl, isopropyl, alkyl having from 4 to 20 carbon atoms, —OCH₃, —OCH₂CH₃, —OCH₂CH₂CH₃, —OCH(CH₃)₂, —OCH₂CH₂CH₂CH₃, —OCH(CH₃)₃, —OCH₂CH₂OCH₃, —Cl, —Br, —I, —NH₂, —NHCH₃, —N(CH₃)₂, —N(Ph)₂,

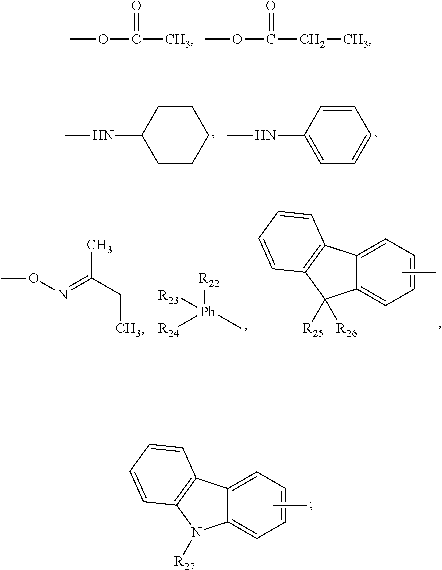

where Ph represents a phenyl and R₂₂, R₂₃, R₂₄, R₂₅, R₂₆ and R₂₇ are selected independently from hydrogen and —R₁₇—Y₃ in which R₁₇ is selected from any one of the meanings of R₁₅ and Y₃ is selected from any one of the meanings of Y₁.

Further embodiments of the invention are illustrated in the appended dependent claims, which form an integral part of the present description.

The dyes according to the present invention are particularly suitable for use as sensitizers for photoelectrochemical cells. The use of substituted heterocyclic benz-x-azole nuclei as terminal of the molecules according to the present invention is particularly useful for various reasons. Firstly, the heterocyclic nucleus is conjugated with the π conjugated system, consequently extending its conjugation. This leads to the production of molecules with absorptions shifted towards the red. Moreover, the benz-x-azole nucleus can be substituted in various positions making it easier to modify the part of the molecule that is used for binding the compound to the inorganic semiconductor in photoelectrochemical cells. For example, the heterocyclic nucleus can be substituted in position 5 or 6, or in both, with functional groups such as the carboxyl, 2-cyanocarboxyl, hydroxyl, phosphonic and boronic groups.

Moreover, the heterocyclic nuclei of the compounds of the present invention are not quaternized on the heterocyclic nitrogen and therefore do not display the associated positive charge. This is particularly important since the positive charge can function as a trap for the electrons that flow towards the surface of the semiconductor, reducing the efficiency of injection of said electrons in the semiconductor layer of the photoelectrochemical device.

The compounds GC24, GC36, GC37 and GC38 described below are particularly useful for making complex structures in which the dye is bound to an optically active nanoparticle that amplifies its properties, both when used in photoelectrochemical cells and when used in photonic devices. Owing to the alkynyl group present in the GC24 and GC36 compounds, these compounds can be reacted with a nanoparticle that has an alkyl azide group on its surface, according to the known reaction of 1,3 dipolar cycloaddition catalysed by Cu(I), obtaining a system consisting of a dye chemically bound to an optically active nanoparticle. The amplification effect can be obtained through transfer of energy from the nanoparticle to the dye if the emission of the nanoparticle is, even partially, superposable on the absorption spectrum of the dye according to the known FRET mechanism.

A similar structure formed from dyes bound chemically to optically active nanoparticles can be obtained similarly by reacting the azide group present in the compounds GC37 and GC38 with an alkynyl group present on the surface of the nanoparticles.

Nanoparticles particularly suitable for forming nanostructures together with the dyes of the present invention, bound chemically to them, are as follows:
quantum dots of diameter between 1 and 10 nm, for example quantum dots of CdSe, CdS, CdTe, PbS, PbSe, PbTe, ZnO, ZnS, ZnSe, ZnTe, SnS, SnSe, SnTe, GaSb, InP, InAs, InSb, CuInS;
composite quantum dots of diameter between 2 and 50 nm composed of a semiconductor coated with a layer of semiconductor of different material, the semiconductors being selected from those listed above;
siliceous nanoparticles incorporating fluorescent dyes of diameter between 5 and 200 nm, both porous and non-porous; porous fluorescent siliceous nanoparticles usable after modification of the external surface with an alkynyl or with an alkyl azide are described for example in E. Gianotti et al. (ACS Appl. Mater. Interfaces, 2009, volume 1, page 678); non-porous fluorescent siliceous nanoparticles usable after surface modification with an alkynyl or with an alkyl azide are described for example in I. Miletto et al. (Dyes & Pigments, 2010, volume 84, page 121);
fluorescent polymeric nanoparticles of diameter between 5 and 200 nm; for example polymeric nanoparticles usable for the purpose, after modification with alkynyl or alkyl azide groups, are described in C. Wu et al. (ACS Nano, 2008, volume 2, page 2415);
fluorescent lipid nanoparticles of diameter between 10 and 400 nm; fluorescent lipid nanoparticles usable after modification with alkynyl or alkyl azide groups are described for example in I. Texier et al. (Journal of Biomedical Optics, 2009, volume 14, page 054005) or in A. Loxley (Drug Delivery Technology, 2009, volume 8, No. 8).

A further preferred embodiment is therefore represented by the following Formula (2):

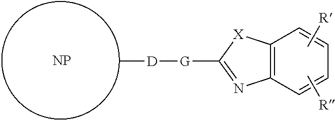

in which X, R′, R″, G and D have the meanings described for Formula (1) and NP represents a nanoparticle selected from the group consisting of quantum dots of diameter between 1 and 10 nm, composite quantum dots of diameter between 2 and 50 nm, porous fluorescent siliceous nanoparticles of diameter between 5 and 200 nm, non-porous fluorescent siliceous nanoparticles of diameter between 5 and 200 nm, fluorescent polymeric nanoparticles of diameter between 5 and 200 nm, and fluorescent lipid nanoparticles of diameter between 10 and 400 nm.

The nanostructures produced by binding the dyes of the present invention chemically with fluorescent nanoparticles can be used for manufacturing cells of the DSSC type as described previously using the dyes only.

Preferred, non-limiting examples of practical application of the invention are the compounds GC1, GC2, GC3, GC4, GC5, GC6, GC7, GC8, GC9, GC10, GC11, GC12, GC13, GC14, GC15, GC16, GC17, GC18, GC19, GC20, GC21, GC22, GC23, GC24, GC25, GC26, GC27, GC28, GC29, GC30, GC31, GC32, GC33, GC34, GC35, GC36, GC37, GC38, GC39 and GC40, the structural formulae of which are described in the appended Claim 3, which forms an integral part of the present description.

The compounds according to the present invention are suitable for use in dye-sensitized solar cells (DSSC) or in photoelectrochemical devices or in photonic devices.

For example the dyes according to Formulae (1) and (2), illustrated by the structures from GC1 to GC40, are particularly suitable for use for sensitizing nanoparticles of a semiconductor, for example titanium dioxide or zinc oxide, deposited on a glass that has been made conductive by deposition of a conductive film of the FTO (fluorine tin oxide) or ITO (indium tin oxide) type, which constitutes the anode of a photoelectrochemical cell. Titanium dioxide is a white semiconductor that does not absorb visible light or the near infrared of solar radiation. The dye endows the dye/titanium dioxide system with the property of also absorbing the part of solar radiation corresponding to the absorption spectrum of the dye itself. Moreover, as a result of impregnation, the dye binds to the titanium dioxide, permitting transfer of electrons, which are promoted to the excited state of the dye as a result of absorption of solar radiation, in the layer of titanium dioxide deposited on the conductive glass and consequently in said conductive layer.

The dyes of the present invention can also be mixed for impregnating the titanium dioxide semiconductor with more than one dye simultaneously. Impregnation with several dyes can also be sequential, or by impregnating the semiconductor with one dye at a time. Alternatively, it is possible to sensitize the semiconductor with a dye, deposit a second layer of semiconductor, even different from the preceding layer, and sensitize said second layer with a dye different from the first dye used. The operation of sensitization of successive layers of semiconductor can be repeated many times. These operations of co-sensitization make it possible to broaden the absorption spectrum of the semiconductor and therefore absorb a broader portion of solar radiation. Sensitization with the dye, or with several dyes, can also be carried out by co-adsorbing non-dye molecules that have the purpose of preventing aggregation of the dye molecules and of avoiding as far as possible phenomena of charge recombination, which lead to lowering of cell performance in terms of overall conversion efficiency of sunlight to electrical energy.

If the anode thus constructed is connected to a counterelectrode, which constitutes the cathode, consisting for example of a layer of platinum, or of carbon, deposited on a conductive glass again of the FTO or ITO type and if the space between the two electrodes, constituting an intermediate layer, is filled with a solution containing a redox couple, for example I⁻/I₃⁻, which has the purpose of regenerating the electrons transferred from the dye to the titanium dioxide, or with a solid or semisolid material, for example a gel, containing a redox couple, for example I⁻/I₃⁻, a photovoltaic cell is constructed of the DSSC type (dye-sensitized solar cell) that is able to generate electric current.

The photovoltaic cells of the DSSC type are thus devices for photoelectric conversion comprising at least one passive substrate (a), which can for example be of glass or of polymer material, on which the following are deposited: a conductive layer (b), a layer intended for the absorption of light, on which at least one dye according to the present invention (c) is deposited, an intermediate layer (d), opposite a counterelectrode (e), and in which said conductive layer (b), said layer intended for absorption of light (c), said dye, said intermediate layer (d) and said counterelectrode (e) are connected in series.

Then connecting (a)(b)(c)(d)(e) in series and connecting, by means of an external circuit, (a) to (e), a photoelectrochemical cell is constructed that is able to generate current and is usable as a dye-sensitized photovoltaic cell.

The material constituting the intermediate layer (d) is generally an electrolyte and in particular the redox couple I⁻/I₃⁻. Rather than using this redox couple dissolved in a liquid solvent, which poses problems for the service life of the device, it is advantageous to use an ionic liquid as charge-carrying conductive material. Alternatively, it may be advantageous to use porous or lamellar inorganic materials, optionally modified with organic molecules that facilitate charge carrying, in which the redox couple is confined.

Examples of such materials are mesoporous silicas of the MCM or SBA type, metal oxides such as magnesium, manganese or vanadium oxide, phyllosilicates such as talc or mica, aluminosilicates, hydrotalcites.

The dyes according to the present invention are synthesized by various methods. As an example, one of the possible methods is described here, which as a generalization comprises the following steps:

a. synthesis of the electron-donating group D;
b. synthesis of the system consisting of the electron-donating group D and the conjugated system G;
c. activation of the system D-G with an aldehyde group —CHO;
d. reaction of the heterocyclic nucleus A with the system D-G-CHO.

The general method described above can be illustrated by the following Scheme 1:

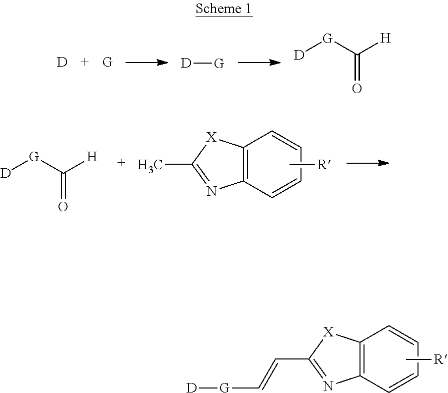

Purely for purposes of illustration, some examples of production of dyes of the invention and uses thereof are described below.

### EXAMPLE 1

### Synthesis of GC1

3.3 mmol of diphenylaminobenzaldehyde is reacted with 5 mmol of 2,3,3-trimethyl-3H-indolo-5-carboxylic acid in a solution of NaOH in triethylamine for 12 h at 80° C. The product GC1 obtained is washed repeatedly with diethyl ether and finally filtered on a sintered glass filter and dried in a vacuum stove at 40° C. for 12 h. The UV-Vis spectrum of the compound dissolved in methanol has an absorption peak at 406 nm.

### EXAMPLE 2

### Synthesis of GC10

The compound 5-[N,N-bis(4-hexyloxyphenylamino)phenyl]-5′-formyl-3,3′-diphenylsilylene-2,2′-bithiophene is synthesized by the method described in Lin et al. Journal of Organic Chemistry, 2010, Vol. 75, page 4778, with the title “Organic Dyes Containing Coplanar Diphenyl-Substituted Dithienosilole Core for Efficient Dye Sensitized Solar Cells”. 3 mmol of this compound is reacted with 5 mmol of the heterocyclic nucleus 2,3,3-trimethyl-3H-indolo-5-carboxylic acid in a solution of NaOH in triethylamine for 12 h at 120° C. The product GC10 obtained is washed repeatedly with diethyl ether and finally filtered on a sintered glass filter and dried in a vacuum stove at 40° C. for 12 h. The UV-Vis spectrum of the compound dissolved in methanol has an absorption peak at 582 nm.

### EXAMPLE 3

### Synthesis of GC12

The compound 5 m-(9-ethyl-9H-carbazol-3-yl)-3′,3″,3′″,4-tetra-n-hexyl-[2,2′,5′,2″,5″,2′″]quaterthiophenyl-5-carbaldehyde is synthesized by the method described in Koumura et al., JACS 2006, volume 128, page 14256, with the title “Alkyl-Functionalized Organic Dyes for Efficient Molecular Photovoltaics”. 2.5 mmol of this compound is reacted with 5 mmol of the heterocyclic nucleus 2,3,3-trimethyl-3H-indolo-5-carboxylic acid in a solution of NaOH in triethylamine for 12 h at 80° C. The product GC12 obtained is washed repeatedly with diethyl ether and finally filtered on a sintered glass filter and dried in a vacuum stove at 40° C. for 12 h. The UV-Vis spectrum of the compound dissolved in methanol has an absorption peak at 546 nm.

### EXAMPLE 4

### Synthesis of GC21

The compound N,N-bis(9,9-dimethylfluoren-2-yl)-4-(4-(2,5-bis(isopentoxy)-4-styrylstyryl)-2,5-bis(isopentoxy)styryl)-2,5-bis(isopentoxy)benzaldehyde was synthesized by the method described in Kim et al., Journal of Organic Chemistry, volume 73, page 7072, with the title “Molecular Engineering of Organic Sensitizers Containing p-Phenylene Vinylene Unit for Dye-Sensitized Solar Cells”. 3 mmol of this compound is reacted with 5 mmol of the heterocyclic nucleus 2,3,3-trimethyl-3H-indolo-5-carboxylic acid in a solution of NaOH in triethylamine for 12 h at 120° C. The product GC21 obtained is washed repeatedly with diethyl ether and finally filtered on a sintered glass filter and dried in a vacuum stove at 40° C. for 12 h. The UV-Vis spectrum of the compound dissolved in methanol has an absorption peak at 525 nm.

### EXAMPLE 5

### Production of a Dye-Sensitized Solar Cell Using Dye GC21

The dye GC21 is used in the production of a DSSC cell according to the general method described on pages 20 and 21. The cell was manufactured following the method published in Kuang et al., Journal of the American Chemical Society, volume 128, page 4146, 2006. The photoanode was constructed by depositing a double layer (8μ+4μ) of titanium dioxide and the conversion efficiency, η, reached a value of 7.8%. DSSC solar cells can be made by a similar method using each of the dyes described in the present invention, also mixed together.

### EXAMPLE 6

### Production of a Nanostructure Obtained by Binding Dye GC24 to a Quantum Dot

The intermediate N,N-bis(4-(hex-5-yn-1-yl)-phenyl)-phenyl-4-(4-(2,5-bis(isopentoxy)-4-styrylstyryl)-2,5-bis(isopentoxy)styryl)-2,5-bis(isopentoxy)benzaldehyde was synthesized by modifying the method described in Kim et al., Journal of Organic Chemistry, volume 73, page 7072, with the title “Molecular Engineering of Organic Sensitizers Containing p-Phenylene Vinylene Unit for Dye-Sensitized Solar Cells”. 3 mmol of this compound is reacted with 5 mmol of the heterocyclic nucleus 2,3,3-trimethyl-3H-indolo-5-carboxylic acid in a solution of NaOH in triethylamine for 12 h at 120° C. The product GC24 obtained is washed repeatedly with diethyl ether and finally filtered on a sintered glass filter and dried in a vacuum stove at 40° C. for 12 h. The UV-Vis spectrum of the compound dissolved in methanol has an absorption peak at 528 nm.

The compound GC24 obtained according to the method described above is reacted with CdSe quantum dots having a diameter of about 2.5 nm emitting at approx. 520 nm, coated with 8-azidooctane-1-thiol. The reaction is carried out, with the aid of microwaves, in DMF by reacting the compound GC24 in excess 20:1 (mol/mol) relative to the azide groups present on the surface of the CdSe quantum dots. The reaction tube is heated in a Biotage Initiator microwave reactor for 40 minutes at 130 degrees Celsius. At the end of this time, the mixture is cooled to room temperature. To remove the excess of dye GC24 the solution is chromatographed on Sephadex G25 resin. The fractions containing the quantum dot-dye nanostructure are combined and stored in DMF at room temperature.

1. D-π-A dye according to Formula (1), including the valence tautomers thereof: 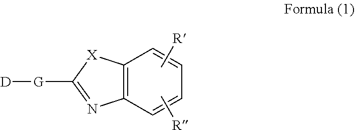
wherein X is selected from C(CH₃)₂, —O, —S, —CH═CH, or 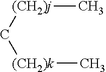
with j=1-20 and k=1-20;
R′ is selected from —COOH, —OH, C≡N, —CHO, —PO₃H, —PO₃⁻, —B(OH)₂, 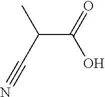
and R₁₅—Y₁ wherein R₁₅ is a linear or branched, saturated or unsaturated alkyl chain, having 3 to 30 carbon atoms, wherein one or more carbon atoms are each optionally replaced with a component selected independently from an oxygen or sulphur atom, an —NH— or —CONH— group, or a cyclic aromatic or non-aromatic 4-, 5- or 6-membered grouping of carbon atoms, wherein one or more carbon atoms are each optionally replaced with a heteroatom selected independently from oxygen, sulphur, nitrogen or selenium, and wherein Y₁ is selected from the group consisting of hydrogen, carboxyl, carbonyl, amino, sulphydryl, thiocyanate, isothiocyanate, isocyanate, maleimide, hydroxyl, phosphoramidite, glycidyl, imidazolyl, carbamoyl, anhydride, bromoacetamide, chloroacetamide, iodoacetamide, sulphonyl halide, acyl halide, aryl halide, hydrazide, succinimidyl ester, hydroxysulphosuccinimidyl ester, phthalimidyl ester, naphthalimidyl ester, monochlorotriazine, dichlorotriazine, mono- or di-halo substituted pyridine, mono- or di-halo substituted diazine, aziridine, imidyl ester, hydrazine, azidonitrophenyl, azide, 3-(2-pyridyldithio)-propionamide, glyoxal, aldehyde, nitrophenyl, dinitrophenyl, trinitrophenyl, —C≡CH and 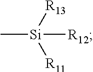
wherein R₁₁, R₁₂ and R₁₃ are selected independently of each other from the group consisting of methyl, ethyl, propyl, isopropyl, —OCH₃, —OCH₂CH₃, —OCH₂CH₂CH₃, —OCH(CH₃)₂, —OCH₂CH₂OCH³, —Cl,
—Br, —I, —N(CH₃)₂, 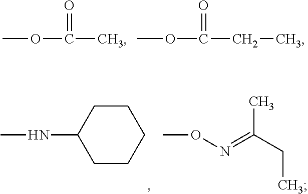
R″ is selected from hydrogen, —COOH, —OH, —C≡N, —CHO, —PO₃H, —PO₃⁻, —B(OH)₂, 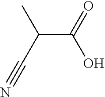
and R₁₆—Y₂ wherein R₁₆ is selected from any of the meanings of R₁₅ and Y₂ is selected from any of the meanings of Y₁;
G is a conjugated system or forms a conjugated system with the adjacent heterocyclic nucleus, the conjugated system consisting of 2 to 200 carbon atoms wherein one or more carbon atoms are each optionally replaced with a component selected independently from an oxygen, sulphur, nitrogen, silicon atom, an —NH— or —CONH— group, or an aromatic 4-, 5- or 6-membered grouping of carbon atoms, wherein one or more carbon atoms are each optionally replaced with a heteroatom selected independently from oxygen, sulphur, nitrogen, silicon or selenium;
D is an electron donating group selected from the group consisting of: 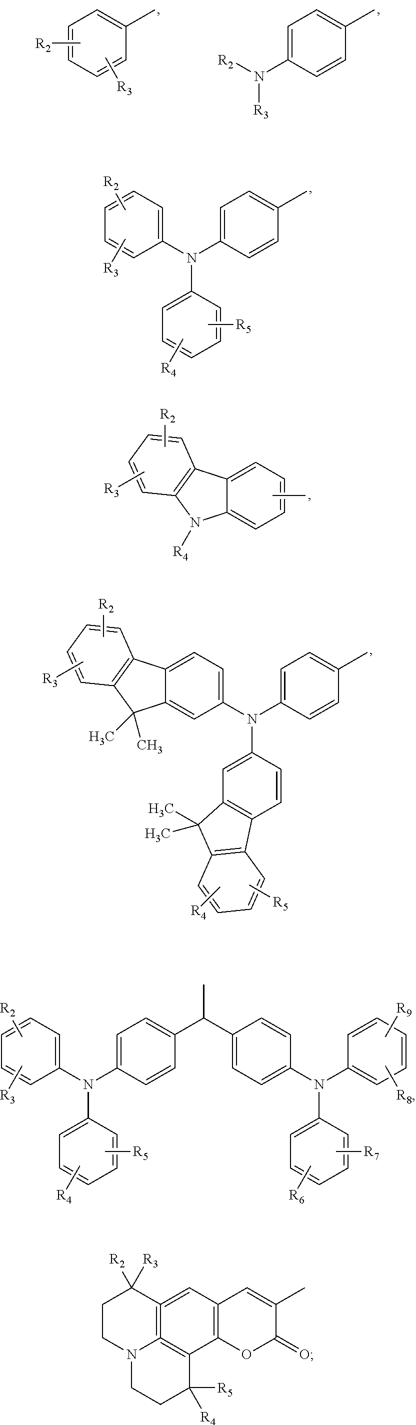
R₂, R₃, R₄, R₅, R₆, R₇, R₈, R₉ are selected independently from the group consisting of hydrogen, hydroxyl, methyl, ethyl, propyl, isopropyl, alkyl having from 4 to 20 carbon atoms, —OCH₃, —OCH₂CH₃, —OCH₂CH₂CH₃, —OCH(CH₃)₂, —OCH₂CH₂CH₂CH₃—OCH(CH₃)₃, —OCH₂CH₂OCH₃, —Cl, —Br, —I, —NH₂, —NHCH₃, —N(CH₃)₂, —N(Ph)₂, 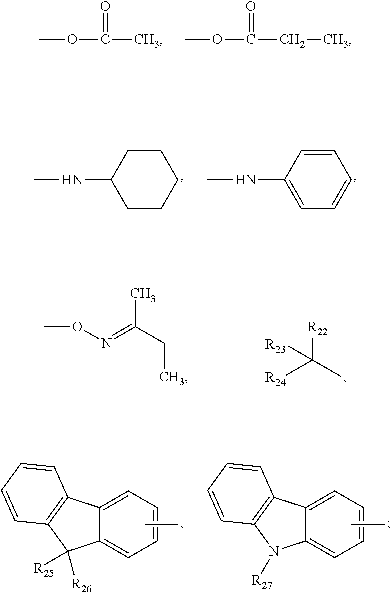
wherein Ph is phenyl and R₂₂, R₂₃, R₂₄, R₂₅, R₂₆ and R₂₇ are selected independently of each other from hydrogen and —R₁₇—Y₃, wherein R₁₇ is selected from any of the meanings of R₁₅, and Y₃ is selected from any of the meanings of Y₁.

2. Dye according to claim 1, wherein R₁₅ is a linear or branched saturated or unsaturated alkyl chain, having 4 to 12 carbon atoms wherein one or more carbon atoms are each optionally replaced with a component selected independently from an oxygen or sulphur atom, an —NH— or —CONH— group, or a cyclic aromatic or non-aromatic 4-, 5- or 6-membered grouping of carbon atoms, wherein one or more carbon atoms are each optionally replaced with a heteroatom selected independently from oxygen, sulphur, nitrogen or selenium and wherein Y₁ is selected from the group consisting of hydrogen, carboxyl, carbonyl, amino, sulphydryl, thiocyanate, isothiocyanate, isocyanate, maleimide, hydroxyl, phosphoramidite, imidazolyl, carbamoyl, anhydride, bromoacetamide, chloroacetamide, iodoacetamide, sulphonyl halide, acyl halide, aryl halide, hydrazide, succinimidyl ester, hydroxysulphosuccinimidyl ester, phthalimidyl ester, naphthalinyl ester, monochlorotriazine, dichlorotriazine, mono- or di-halo substituted pyridine, mono- or di-halo substituted diazine, aziridine, imidyl ester, hydrazine, azidonitrophenyl, azide, 3-(2-pyridyldithio)-propionamide, glyoxal, aldehyde, nitrophenyl, dinitrophenyl, trinitrophenyl, —C≡CH and 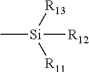
R₁₁, R₁₂ and R₁₃ are as defined in claim 1.

3. Dye according to claim 1, which is selected from the group consisting of the following compounds, including the valence tautomers thereof:

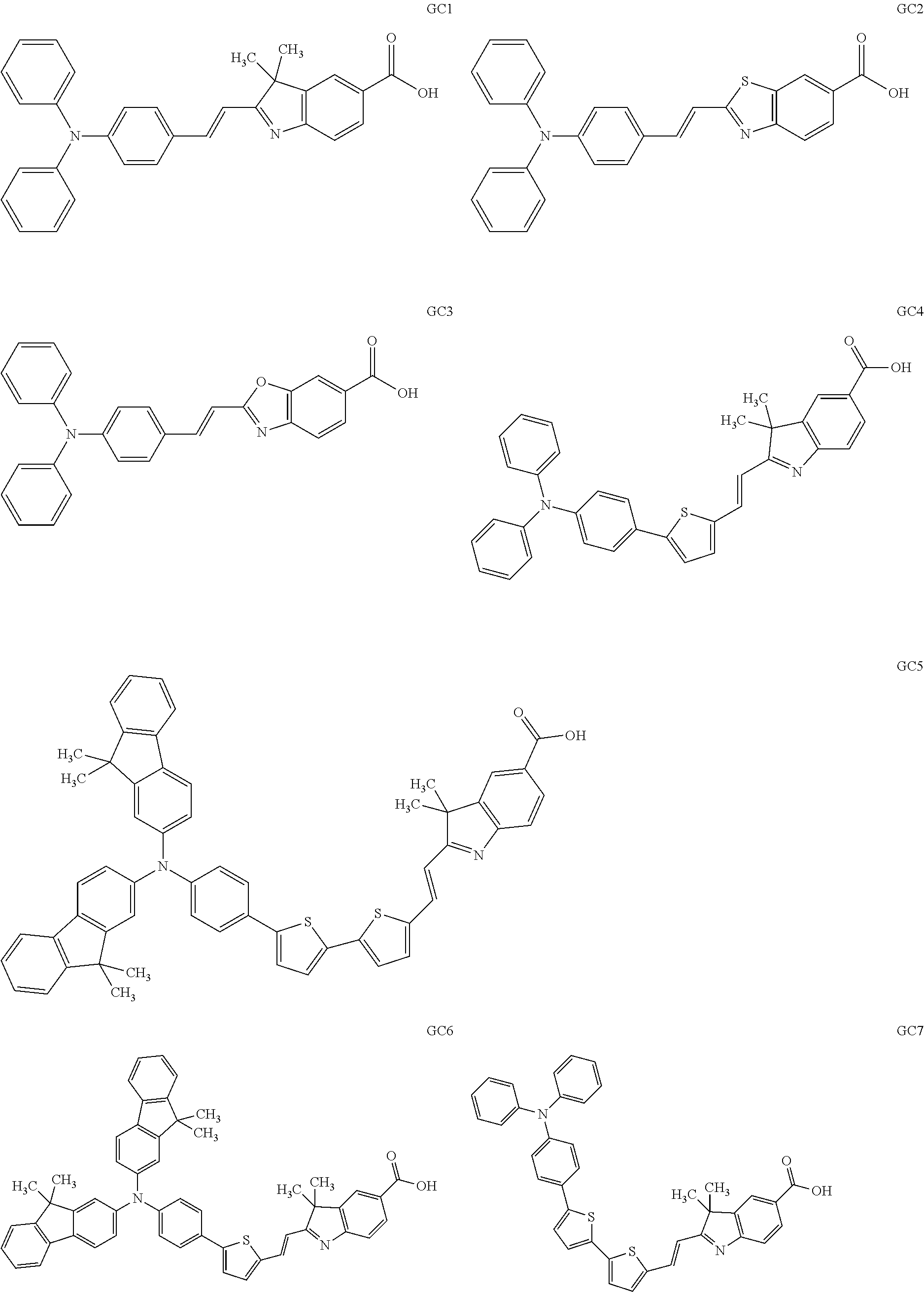

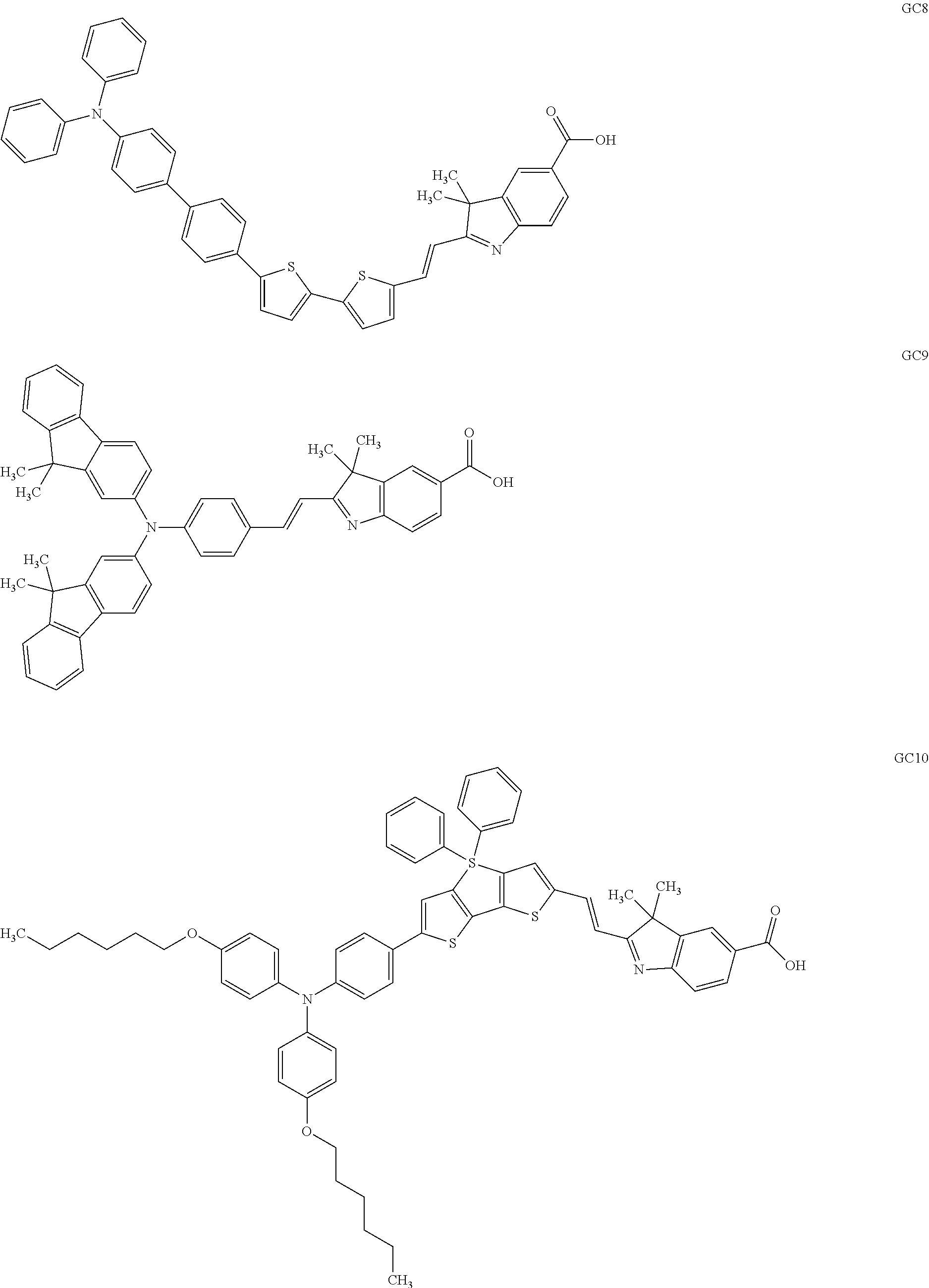 [SMILES: CC1(C)C(/C=C/c2ccc(-c3ccc(-c4ccc(-c5ccc(N(c6ccccc6)c6ccccc6)cc5)cc4)s3)s2)=Nc2ccc(C(=O)O)cc21 ; CC1(C)C(/C=C/c2ccc(N(c3ccc4c(c3)C(C)(C)c3ccccc3-4)c3ccc4c(c3)C(C)(C)c3ccccc3-4)cc2)=Nc2ccc(C(=O)O)cc21 ; CCCCCCOc1ccc(N(c2ccc(OCCCCCC)cc2)c2ccc(-c3cc4c(s3)-c3sc(/C=C/C5=Nc6ccc(C(=O)O)cc6C5(C)C)cc3S4(c3ccccc3)c3ccccc3)cc2)cc1]

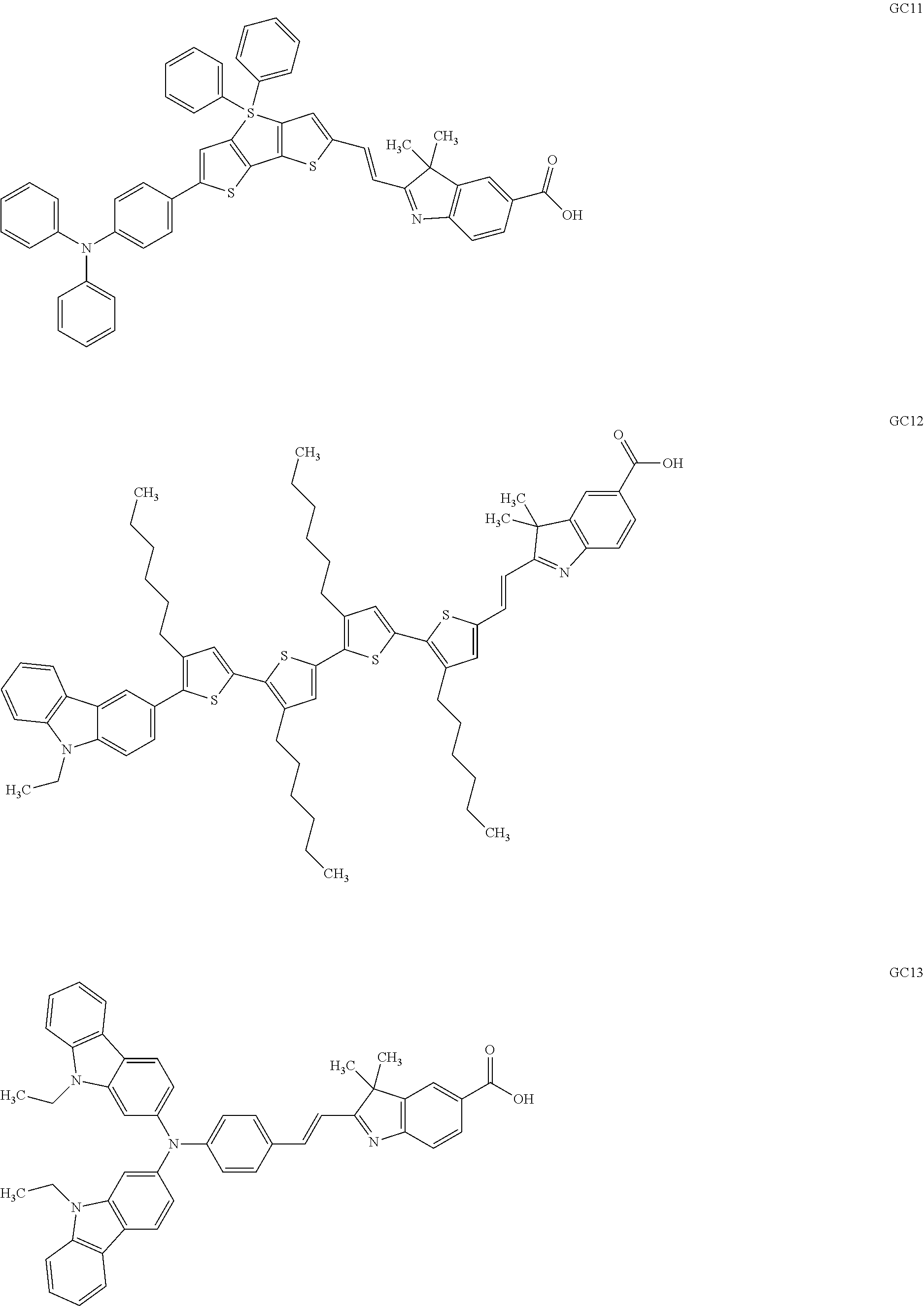 [SMILES: CC1(C)C(/C=C/c2cc3c(s2)-c2sc(-c4ccc(N(c5ccccc5)c5ccccc5)cc4)cc2S3(c2ccccc2)c2ccccc2)=Nc2ccc(C(=O)O)cc21 ; CCCCCCc1cc(-c2sc(-c3sc(-c4sc(/C=C/C5=Nc6ccc(C(=O)O)cc6C5(C)C)cc4CCCCCC)cc3CCCCCC)cc2CCCCCC)sc1-c1ccc2c(c1)c1ccccc1n2CC ; CCn1c2ccccc2c2ccc(N(c3ccc(/C=C/C4=Nc5ccc(C(=O)O)cc5C4(C)C)cc3)c3ccc4c5ccccc5n(CC)c4c3)cc21]

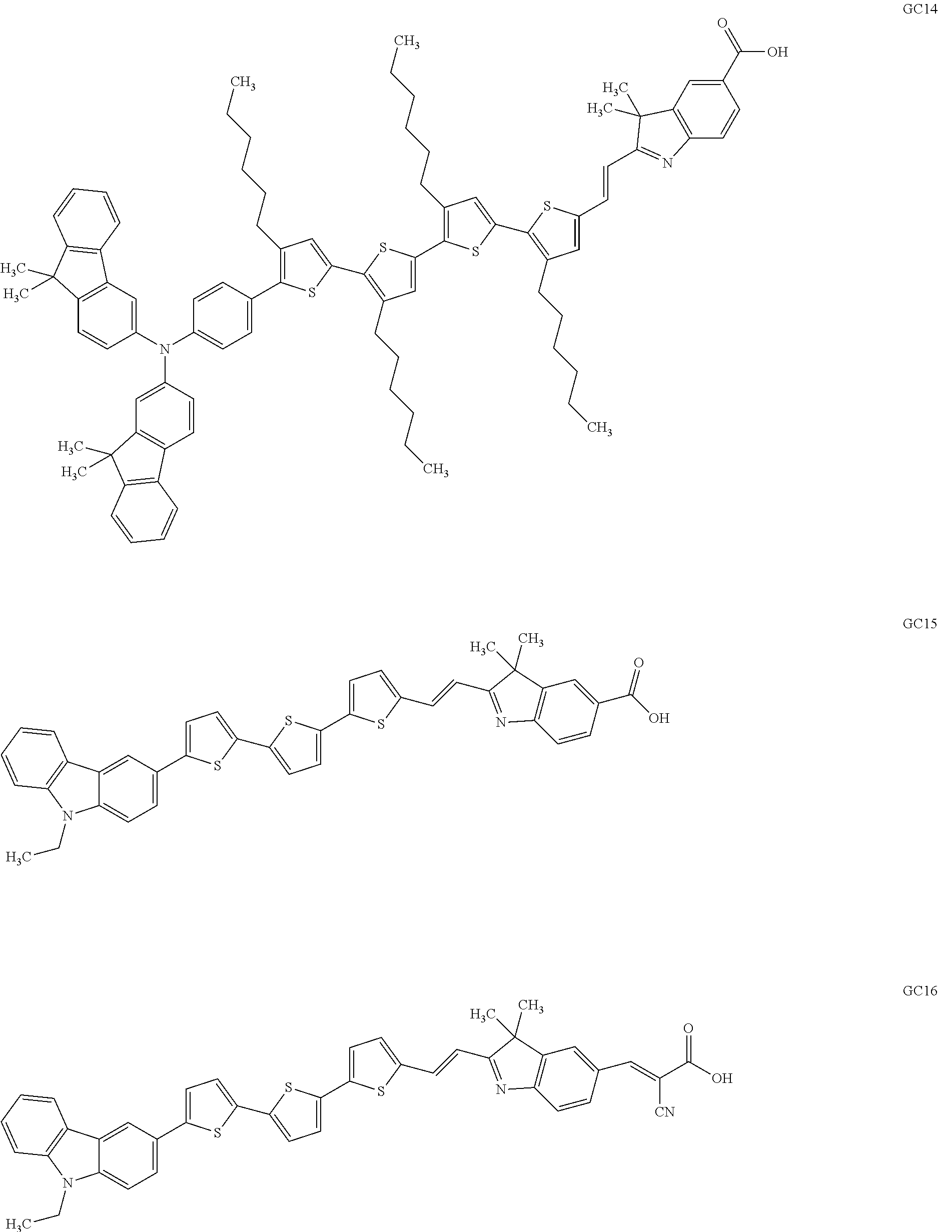 [SMILES: CCCCCCc1cc(-c2sc(-c3sc(-c4sc(/C=C/C5=Nc6ccc(C(=O)O)cc6C5(C)C)cc4CCCCCC)cc3CCCCCC)cc2CCCCCC)sc1-c1ccc(N(c2ccc3c(c2)-c2ccccc2C3(C)C)c2ccc3c(c2)C(C)(C)c2ccccc2-3)cc1 ; CCn1c2ccccc2c2cc(-c3ccc(-c4ccc(-c5ccc(/C=C/C6=Nc7ccc(C(=O)O)cc7C6(C)C)s5)s4)s3)ccc21 ; CCn1c2ccccc2c2cc(-c3ccc(-c4ccc(-c5ccc(/C=C/C6=Nc7ccc(/C=C(\C#N)C(=O)O)cc7C6(C)C)s5)s4)s3)ccc21]

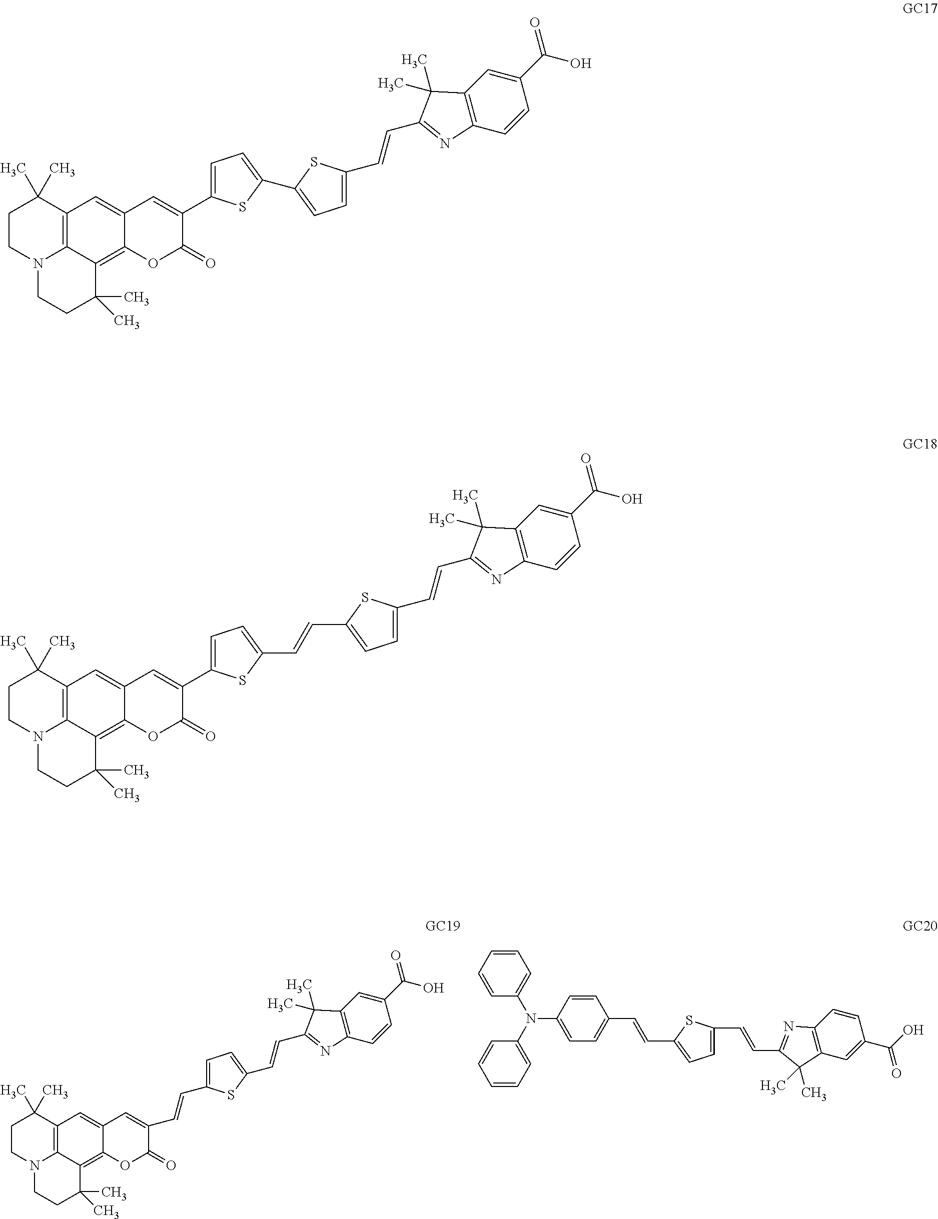 [SMILES: CC1(C)CCN2CCC(C)(C)c3c2c1cc1cc(-c2ccc(-c4ccc(/C=C/C5=Nc6ccc(C(=O)O)cc6C5(C)C)s4)s2)c(=O)oc31 ; CC1(C)CCN2CCC(C)(C)c3c2c1cc1cc(-c2ccc(/C=C/c4ccc(/C=C/C5=Nc6ccc(C(=O)O)cc6C5(C)C)s4)s2)c(=O)oc31 ; CC1(C)CCN2CCC(C)(C)c3c2c1cc1cc(/C=C/c2ccc(/C=C/C4=Nc5ccc(C(=O)O)cc5C4(C)C)s2)c(=O)oc31 ; CC1(C)C(/C=C/c2ccc(/C=C/c3ccc(N(c4ccccc4)c4ccccc4)cc3)s2)=Nc2ccc(C(=O)O)cc21]

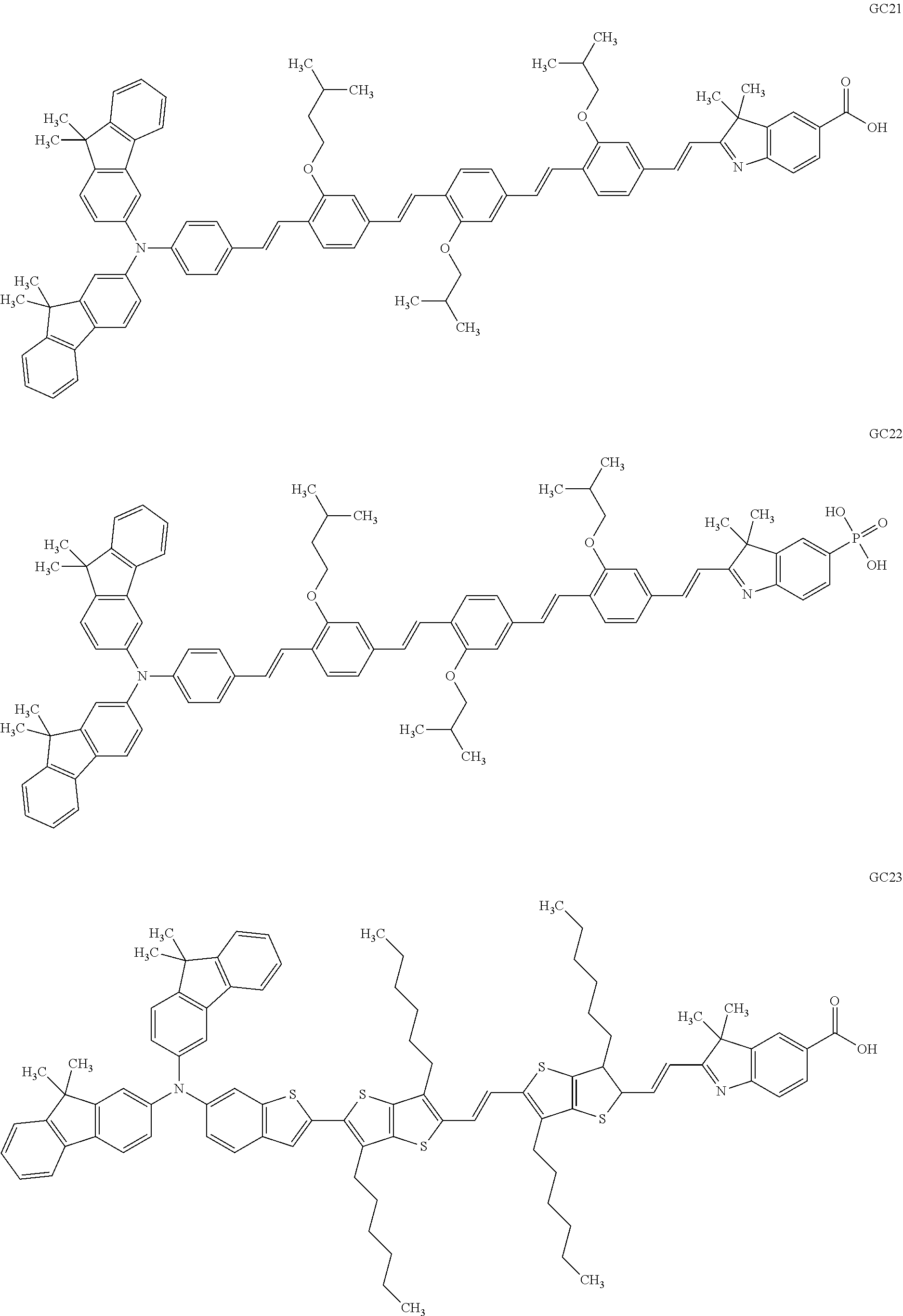

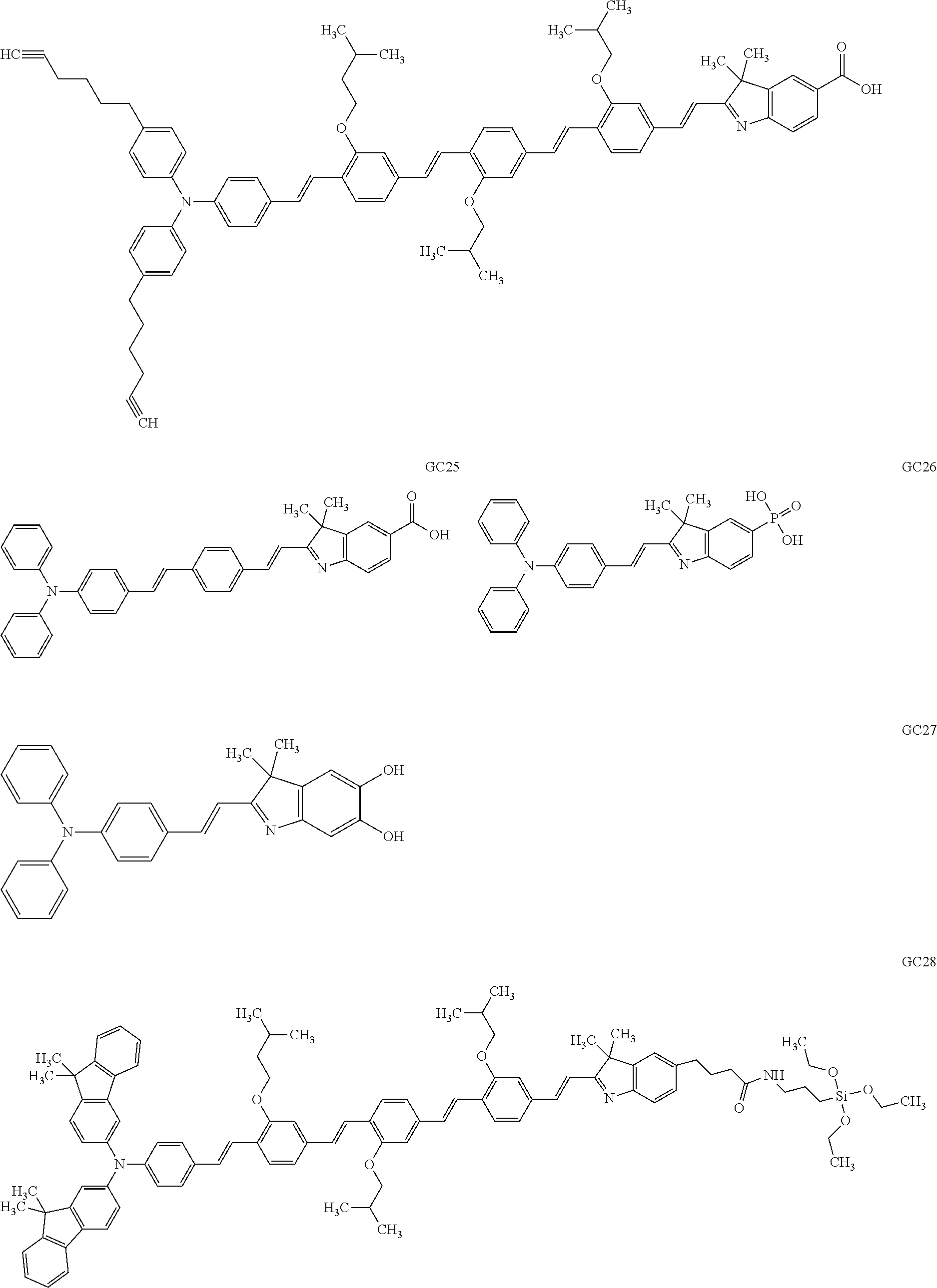

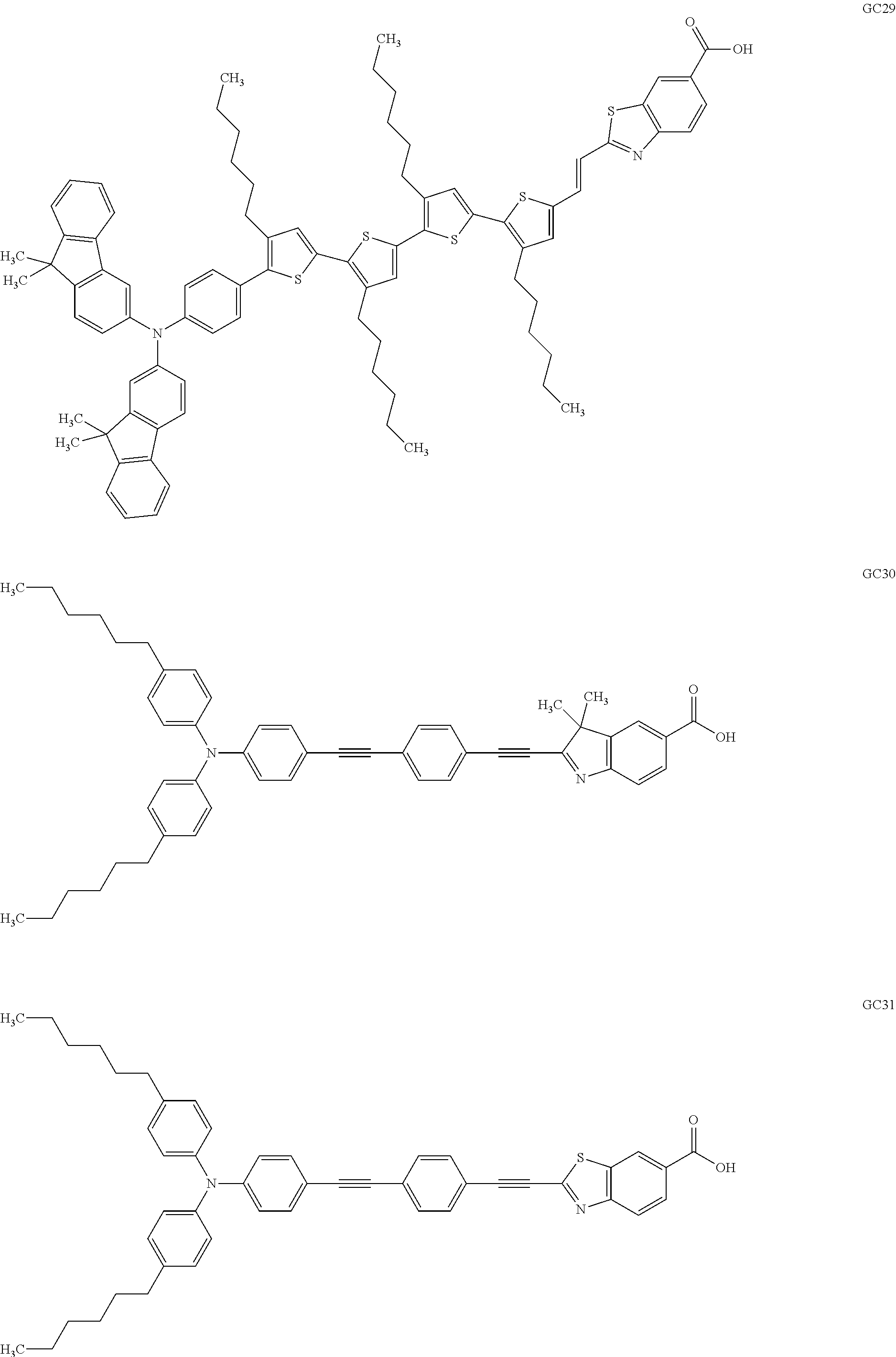 [SMILES: CCCCCCc1cc(-c2sc(-c3sc(-c4sc(/C=C/c5nc6ccc(C(=O)O)cc6s5)cc4CCCCCC)cc3CCCCCC)cc2CCCCCC)sc1-c1ccc(N(c2ccc3c(c2)-c2ccccc2C3(C)C)c2ccc3c(c2)C(C)(C)c2ccccc2-3)cc1 ; CCCCCCc1ccc(N(c2ccc(C#Cc3ccc(C#CC4=Nc5ccc(C(=O)O)cc5C4(C)C)cc3)cc2)c2ccc(CCCCCC)cc2)cc1 ; CCCCCCc1ccc(N(c2ccc(C#Cc3ccc(C#Cc4nc5ccc(C(=O)O)cc5s4)cc3)cc2)c2ccc(CCCCCC)cc2)cc1]

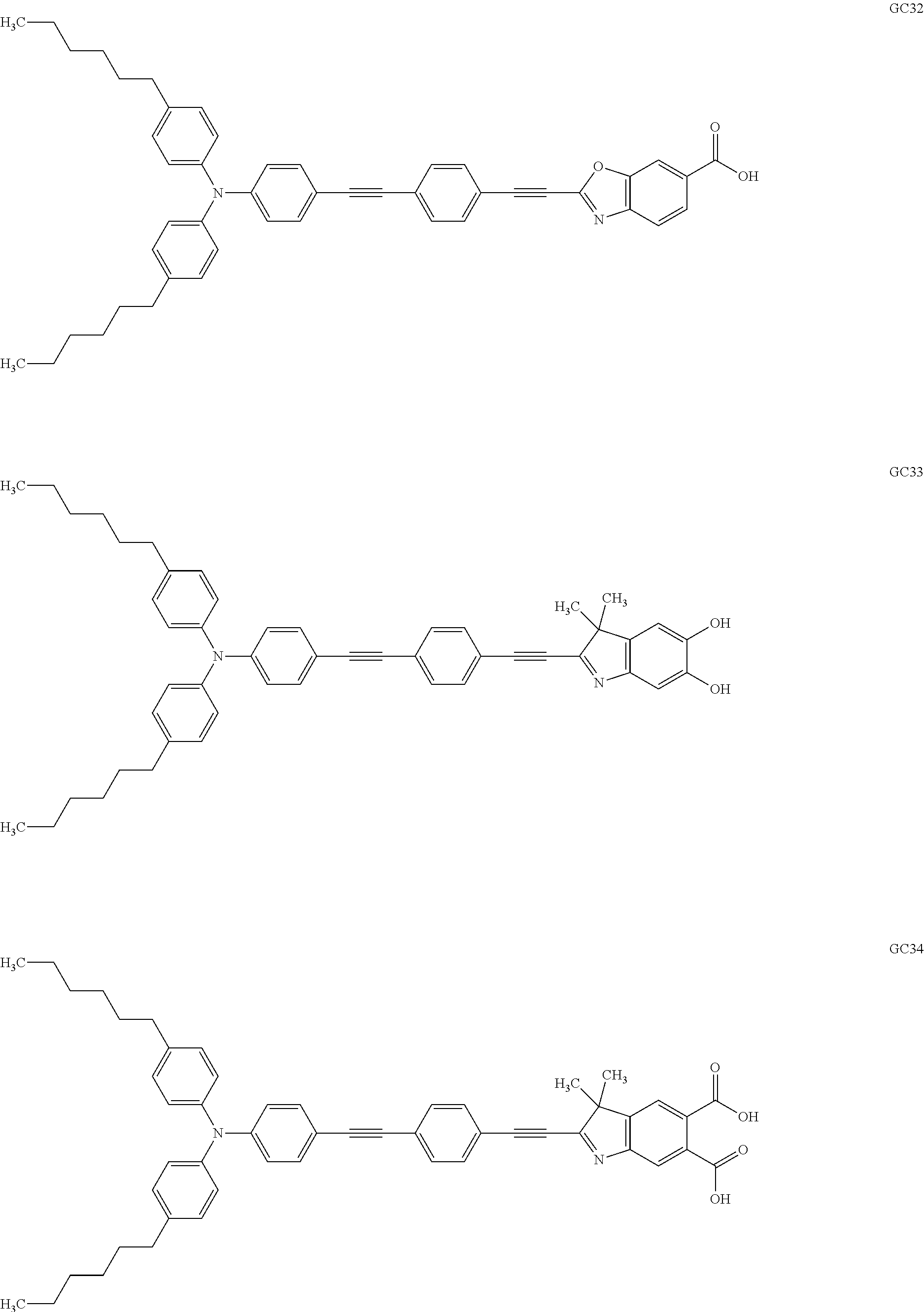 [SMILES: CCCCCCc1ccc(N(c2ccc(C#Cc3ccc(C#Cc4nc5ccc(C(=O)O)cc5o4)cc3)cc2)c2ccc(CCCCCC)cc2)cc1 ; CCCCCCc1ccc(N(c2ccc(C#Cc3ccc(C#CC4=Nc5cc(O)c(O)cc5C4(C)C)cc3)cc2)c2ccc(CCCCCC)cc2)cc1 ; CCCCCCc1ccc(N(c2ccc(C#Cc3ccc(C#CC4=Nc5cc(C(=O)O)c(C(=O)O)cc5C4(C)C)cc3)cc2)c2ccc(CCCCCC)cc2)cc1]

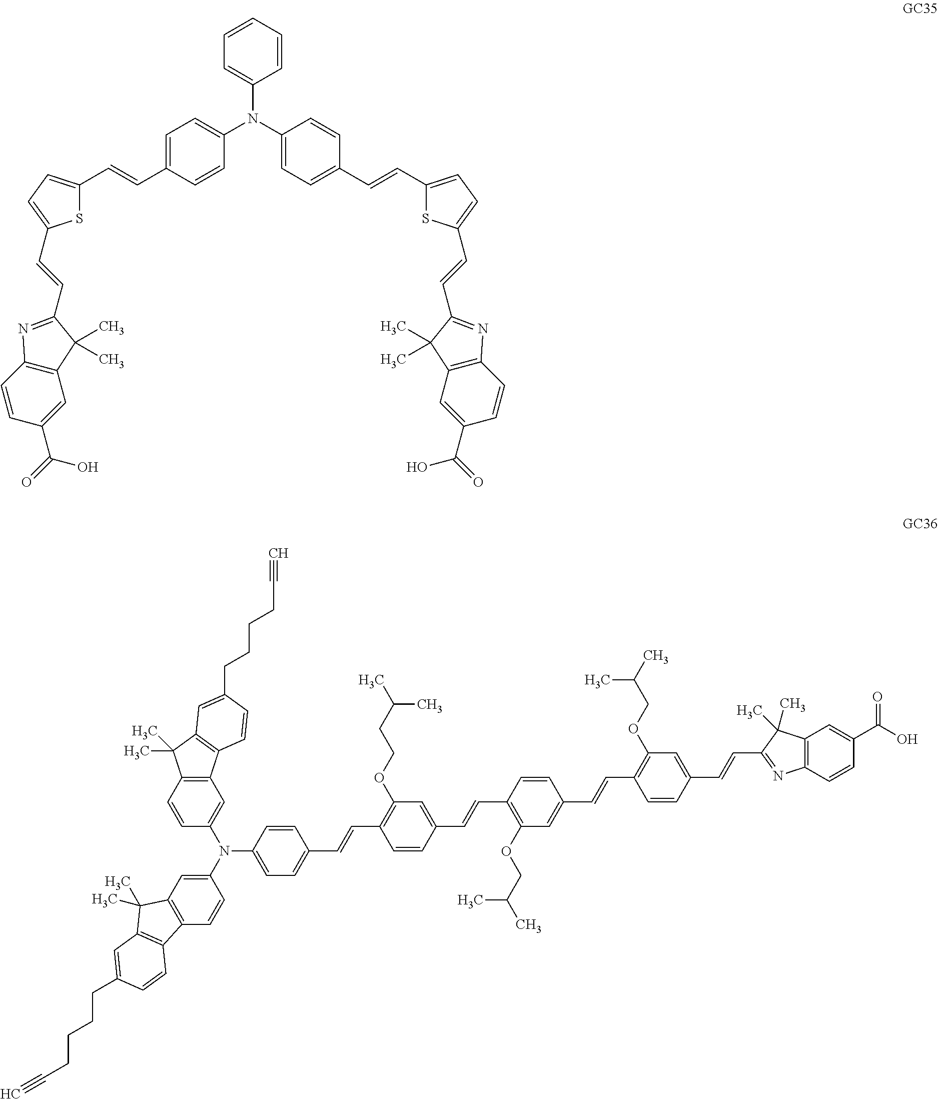 [SMILES: CC1(C)C(/C=C/c2ccc(/C=C/c3ccc(N(c4ccccc4)c4ccc(/C=C/c5ccc(/C=C/C6=Nc7ccc(C(=O)O)cc7C6(C)C)s5)cc4)cc3)s2)=Nc2ccc(C(=O)O)cc21 ; C#CCCCCc1ccc2c(c1)C(C)(C)c1ccc(N(c3ccc(/C=C/c4ccc(/C=C/c5ccc(/C=C/c6ccc(/C=C/C7=Nc8ccc(C(=O)O)cc8C7(C)C)cc6OCC(C)C)cc5OCC(C)C)cc4OCCC(C)C)cc3)c3ccc4c(c3)C(C)(C)c3cc(CCCCC#C)ccc3-4)cc1-2]

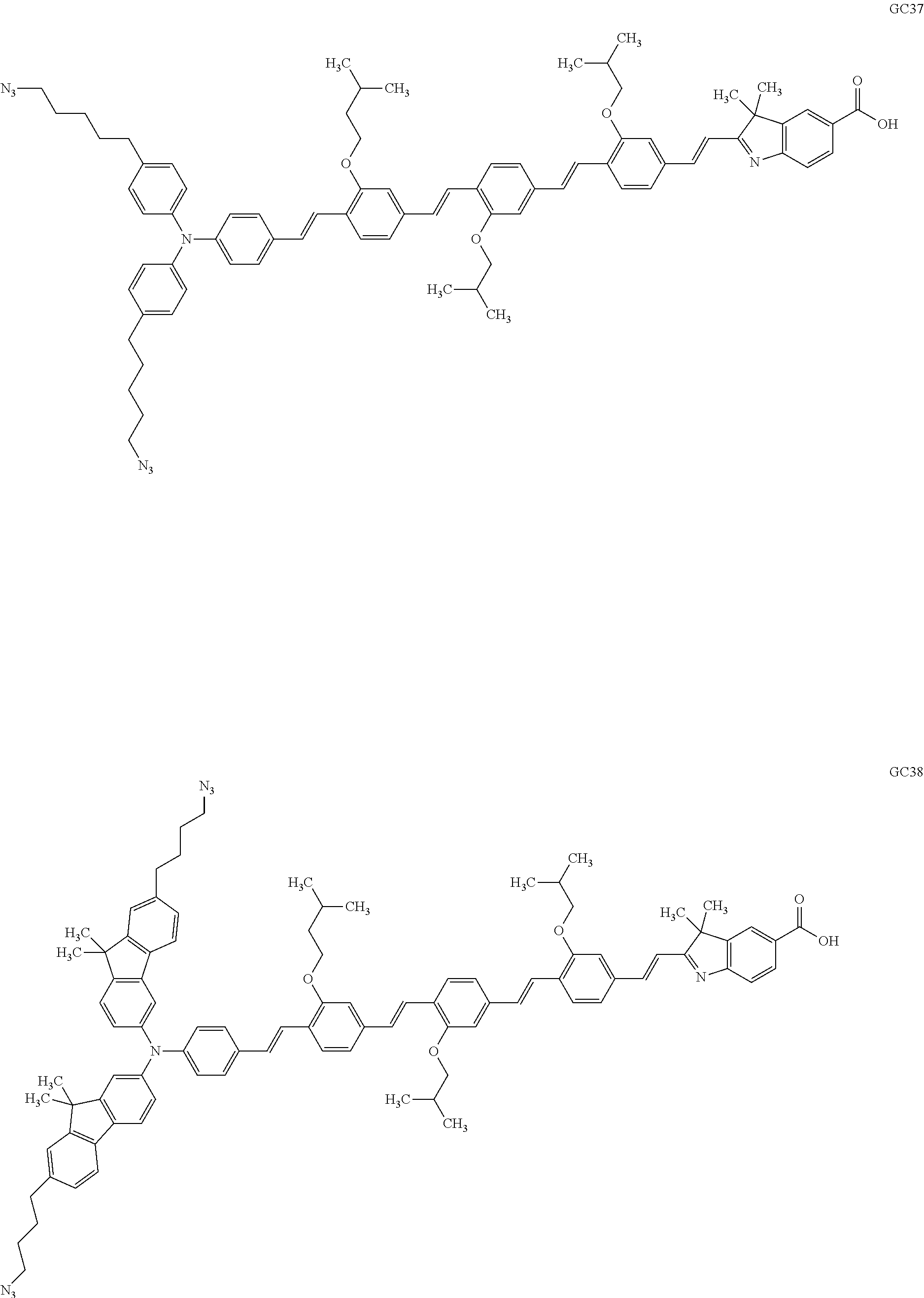 [SMILES: CC(C)CCOc1cc(/C=C/c2ccc(/C=C/c3ccc(/C=C/C4=Nc5ccc(C(=O)O)cc5C4(C)C)cc3OCC(C)C)cc2OCC(C)C)ccc1/C=C/c1ccc(N(c2ccc(CCCCCN=[N+]=[N-])cc2)c2ccc(CCCCCN=[N+]=[N-])cc2)cc1 ; CC(C)CCOc1cc(/C=C/c2ccc(/C=C/c3ccc(/C=C/C4=Nc5ccc(C(=O)O)cc5C4(C)C)cc3OCC(C)C)cc2OCC(C)C)ccc1/C=C/c1ccc(N(c2ccc3c(c2)-c2ccc(CCCCN=[N+]=[N-])cc2C3(C)C)c2ccc3c(c2)C(C)(C)c2cc(CCCCN=[N+]=[N-])ccc2-3)cc1]

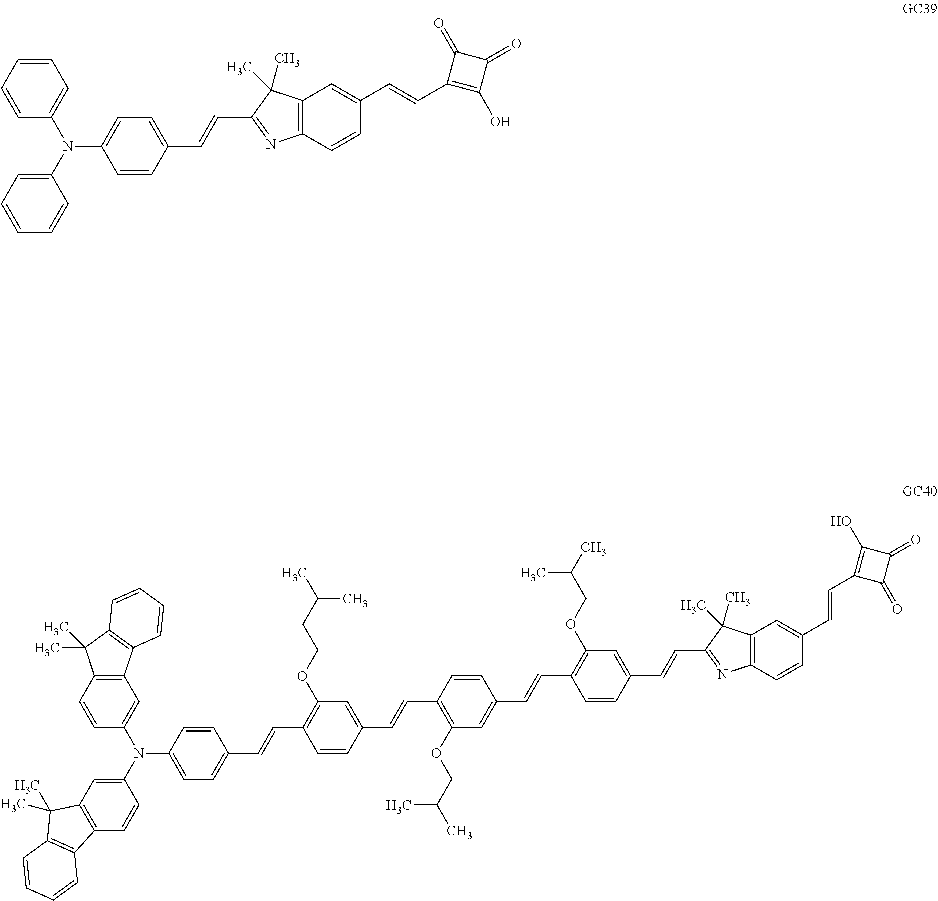 [SMILES: CC1(C)C(/C=C/c2ccc(N(c3ccccc3)c3ccccc3)cc2)=Nc2ccc(/C=C/c3c(O)c(=O)c3=O)cc21 ; CC(C)CCOc1cc(/C=C/c2ccc(/C=C/c3ccc(/C=C/C4=Nc5ccc(/C=C/c6c(O)c(=O)c6=O)cc5C4(C)C)cc3OCC(C)C)cc2OCC(C)C)ccc1/C=C/c1ccc(N(c2ccc3c(c2)-c2ccccc2C3(C)C)c2ccc3c(c2)C(C)(C)c2ccccc2-3)cc1]

4. Dye according to claim 1, which is conjugated with an optically active nanoparticle (NP), preferably fluorescent.

5. Dye according to claim 4, which is represented by the following Formula (2): 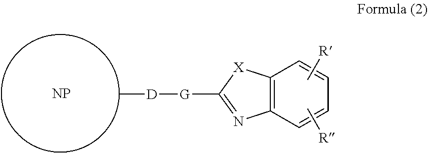
and NP is a nanoparticle selected from the group consisting of quantum dots with a diameter from 1 to 10 nm, composite quantum dots with a diameter between 2 and 50 mm, porous fluorescent silica nanoparticles with a diameter between 5 and 200 nm, non-porous fluorescent silica nanoparticles with a diameter between 5 and 200 nm, fluorescent polymeric nanoparticles with a diameter between 5 and 200 nm, fluorescent lipid nanoparticles with a diameter between 10 and 400 nm.

6. Dye sensitized solar cell (DSSC), comprising a dye according to claim 1.

7. Dye sensitized solar cell (DSSC), comprising a plurality of dyes according to claim 1.

8. Photoelectric conversion device comprising at least a passive substrate having deposited thereon: a conductive layer, a light-absorbing layer having at least one dye according to claim 1 deposited thereon, an intermediate layer and a counter-electrode, wherein said conductive layer, said light-absorbing layer, said dye according to claim 1, said intermediate layer and said counter-electrode are connected in series.

9. Device according to claim 8, wherein the passive substrate is glass or polymeric material.

10. Device according to claim 9, wherein the polymeric material is selected from the group consisting of polyethylene terephthalate, polyethylene naphthalate, polycarbonate, polypropylene, polyimide, 3-acetylcellulose and polyethersulphone.

11. Device according to claim 8, wherein the intermediate layer consists of an electrolyte and a charge transport electrically conductive material.

12. Device according to claim 8, wherein the charge transport electrically conductive material is an ionic liquid or a porous or lamellar inorganic material.

13. Device according to claim 8, wherein the intermediate layer consists of the redox couple I⁻/I₃⁻ dissolved in an organic solvent, or a redox couple I⁻/I₃⁻ dissolved in an ionic liquid, or a redox couple I⁻/I₃⁻ confined in an inorganic material, or a redox couple I⁻/I₃⁻ confined in an inorganic material modified with organic molecules.
